(19) United States
(12) Patent Application Publication
(10) Pub. No.: US 2002/0147064 A1
(43) Pub. Date: Oct. 10, 2002

(54) Unidirectional wheel driving assembly for vehicle

(76) Inventor: Peng Chong Chen, Taichung Hsien (TW)

Correspondence Address: CHARLES E. BAXLEY, 5th Floor, 59 John Street, New York, NY, 10038, US

(21) Appl. No.: 09/828,251

(22) Filed: Apr. 9, 2001

(51) Int. Cl. F16H 7/00; F16H 55/12; F16H 55/30

(52) U.S. Cl. 474/158; 474/159

(57) ABSTRACT

A unidirectional wheel driving device for a vehicle includes a rotary member engaged on the axle of a wheel, a unidirectional bearing device engaged between the rotary member and the wheel axle, and a motor coupled to the rotary member to drive the wheel with a coupling device. The unidirectional bearing device includes a barrel secured on the axle, a sleeve secured in the rotary member, and a bearing engaged between the sleeve and the barrel for preventing the motor from being actuated when the vehicle is pushed by the users.

### BACKGROUND OF THE INVENTION

1. Field of the Invention

The present invention relates to a wheel driving assembly, and more particularly to a unidirectional wheel driving assembly for vehicles.

2. Description of the Prior Art

Various kinds of typical electrically motorized vehicles, such as the motorized scooters, the motorized cycles, the motorized wheel chairs, etc., have been developed and used today. The electrically motorized vehicles include a motor directly coupled to one of the wheels or the wheel axles or indirectly coupled to the wheel axle with a sprocket-and-chain or a pulley-and-belt coupling mechanism, for rotating or driving the wheels of the vehicles. However, when the battery of the vehicle is consumed or is run out, the vehicle may have a good chance to be pushed by the users. When the vehicle is pushed by the users, either forward or rearward, the motor, particularly the spindle of the motor may still be rotated by the wheels, such that the parts or the elements of the motor may be damaged. In addition, the users have to spend a lot of force to overcome the frictional force of the parts or elements of the motor in order to move or to push the vehicle forward or rearward.

The present invention has arisen to mitigate and/or obviate the afore-described disadvantages of the conventional wheel driving assemblies for electric motor driving vehicles.

### SUMMARY OF THE INVENTION

The primary objective of the present invention is to provide a unidirectional wheel driving assembly for allowing the vehicle to be driven unidirectionally and for preventing the motor from being actuated when the vehicle is pushed by the users.

The further objective of the present invention is to provide a unidirectional wheel driving assembly for preventing the spindle of the motor from being rotated or actuated when the vehicle is pushed by the users, and thus for increasing the working life of the spindle of the motor.

The other objective of the present invention is to provide a unidirectional wheel driving assembly for allowing the vehicle to be moved or pushed with less force.

In accordance with one aspect of the invention, there is provided a unidirectional wheel driving assembly for a vehicle, the unidirectional wheel driving assembly comprising a wheel including an axle, a rotary member engaged on the axle, a unidirectional bearing device engaged between the rotary member and the wheel for unidirectionally coupling the rotary member to the axle, a motor, and means for coupling the motor to the rotary member to drive the wheel by the motor.

The unidirectional bearing device includes a barrel secured on the axle and rotated in concert with the axle, a sleeve secured in the rotary member, and a unidirectional bearing member engaged between the sleeve and the barrel.

The sleeve includes at least one protrusion extended therefrom and engaged into the rotary member for solidly securing the sleeve to the rotary member.

The coupling means includes a pulley secured to the motor, and a belt coupled between the pulley and the rotary member.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial plane view of a unidirectional wheel driving assembly for vehicle in accordance with the present invention;

FIG. 2 is a partial exploded view of the unidirectional wheel driving assembly;

FIG. 3 is a partial perspective view of the unidirectional wheel driving assembly;

FIG. 4 is a partial cross sectional view taken along lines 4-4 of FIG. 3; and

FIG. 5 is a partial plane schematic view similar to FIG. 1, illustrating the operation of the unidirectional wheel driving assembly for the vehicles.

### DETAILED DESCRIPTION OF THE PREFERRED EMBODIMENT

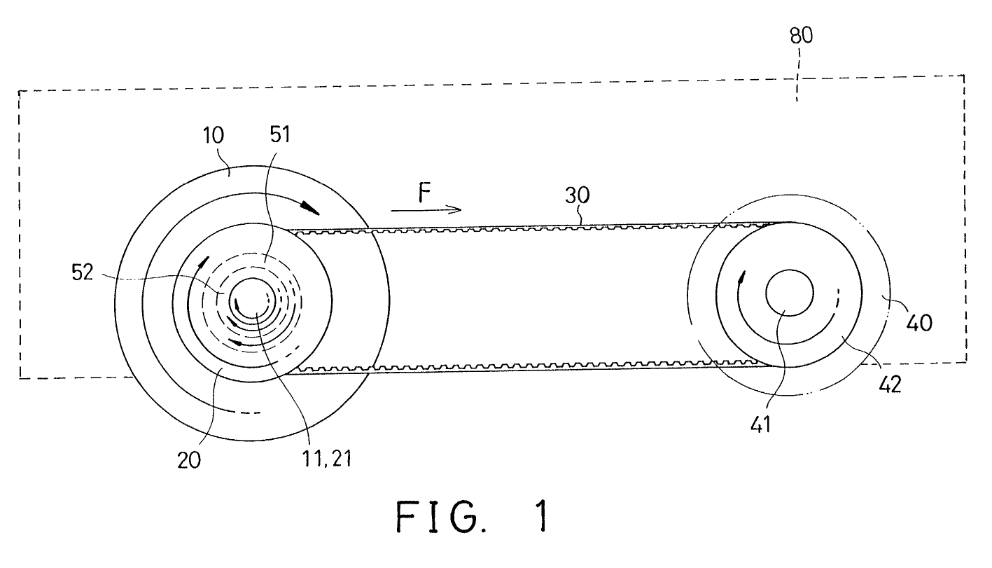

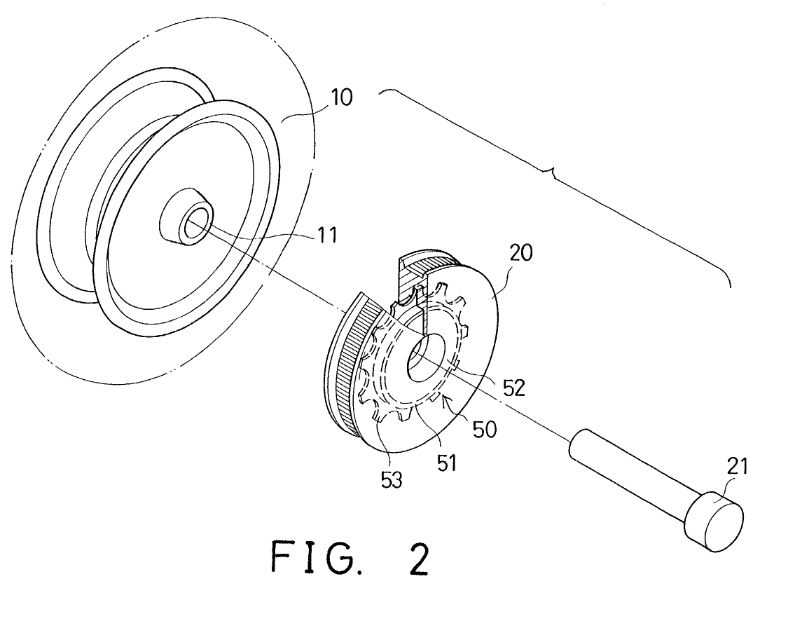

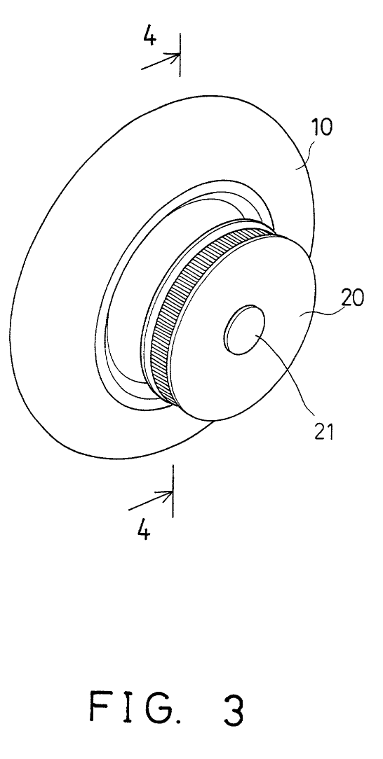

Referring to the drawings, and initially to FIGS. 1-4, a unidirectional wheel driving assembly in accordance with the present invention comprises a motor 40 for attaching or securing to a vehicle 80. A pulley 42 is secured to the spindle 41 of the motor 40 so as to be rotated or driven by the motor 40. One or more wheels 10 rotatably secured to the vehicle 80. For example, as shown in FIGS. 2-4, the wheel 10 includes a hub 11, and an axle 21 secured in the hub 11 and rotated in concert with the wheel 10. A rotary member 20, such as another pulley 20 is rotatably engaged on the axle 21 with a bearing device, particularly a unidirectional bearing device 50 and coupled to the pulley 42 with a belt 30 or the like, such that the wheel 10 may be rotated or driven by the motor 40 unidirectionally.

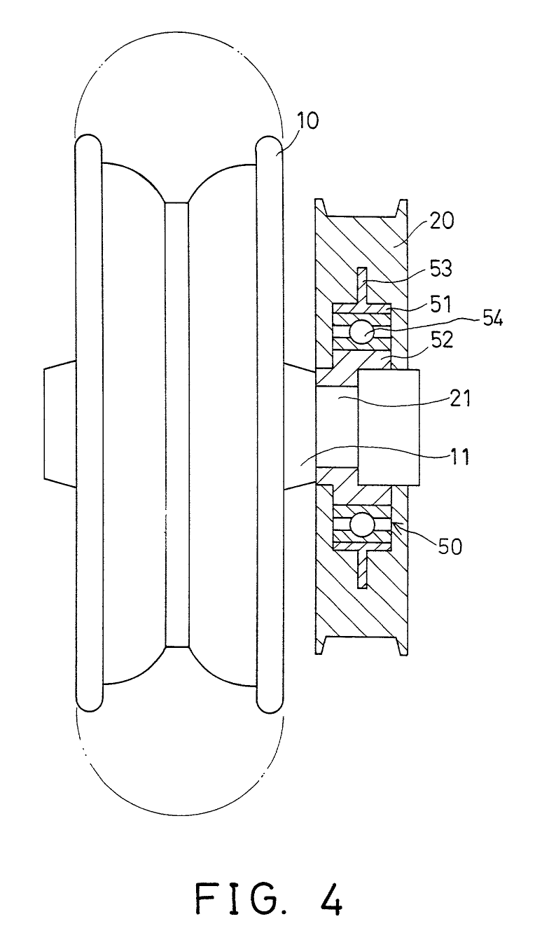

As shown in FIGS. 2 and 4, the unidirectional bearing device 50 includes a barrel 52 secured on the shaft 21 with such as a key or the like, and includes a sleeve 51 unidirectionally engaged on the barrel 52 with a unidirectional bearing member 54. The sleeve 51 includes one or more protrusions 53 extended radially outward from the outer peripheral portion thereof for engaging into the pulley 20 and for solidly securing the unidirectional bearing device 50 in the pulley 20. The pulley 20 may be made of such as the metal materials, the plastic materials, or the like, and may be formed by such as the molding or the mold injection processes, such that the protrusions 53 of the sleeve 51 may be solidly engaged in the pulley 20.

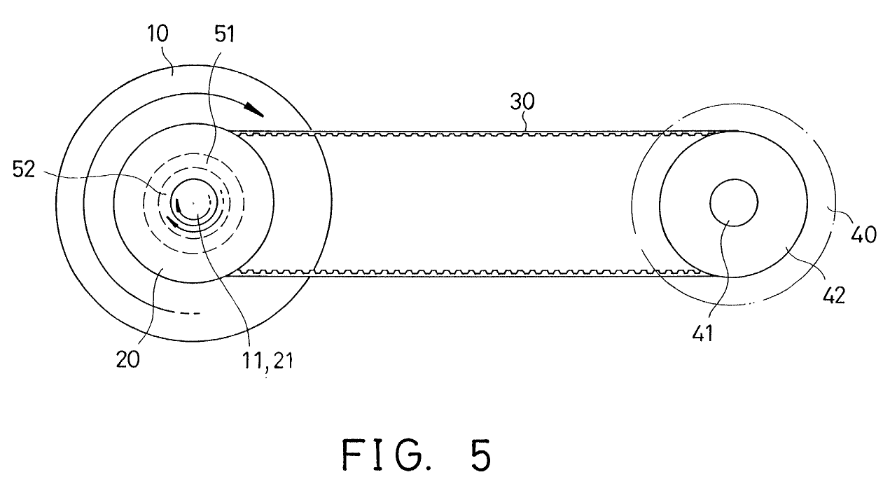

In operation, as shown in FIG. 1, when the pulley 20 is rotated or driven by the motor 40 via the pulley 42 and the belt 30 which may apply a force F against the pulley 20, the wheel 10 may be rotated or driven to move or rotate clockwise by the motor. The wheel 10 may rotate freely relative to the axle 21 in the reverse direction or in the counterclockwise direction by the unidirectional bearing member 54. As shown in FIG. 5, when the motor 40 is not energized, the belt 30 will no longer apply a force against the pulley 20, the wheel 10 may be rotated clockwise and the pulley 20 will not be rotated or driven by the wheel 10 due to the unidirectional bearing member 54 of the unidirectional bearing device 50.

It is to be noted that, as shown in the drawings, the motor 40 is coupled to the wheel 10 with a pulley-and-belt coupling mechanism. However, alternatively, the motor 40 may also be coupled to the wheel 10 with the other coupling mechanisms, such as the sprocket-and-chain coupling mechanism, or the like, for allowing the wheel 10 to be driven by the motor 40.

Accordingly, the unidirectional wheel driving assembly in accordance with the present invention may be used for allowing the vehicle to be driven unidirectionally and for preventing the motor from being actuated when the vehicle is pushed by the users, or for preventing the spindle of the motor from being rotated or actuated when the vehicle is pushed by the users, and thus for increasing the working life of the spindle of the motor, and/or for allowing the vehicle to be moved or pushed with less force.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A unidirectional wheel driving assembly for a vehicle, said unidirectional wheel driving assembly comprising:
a wheel including an axle,
a rotary member engaged on said axle,
a unidirectional bearing device engaged between said rotary member and said wheel for unidirectionally coupling said rotary member to said axle,
a motor, and
means for coupling said motor to said rotary member to drive said wheel by said motor.

2. The unidirectional wheel driving assembly according to claim 1, wherein said unidirectional bearing device includes a barrel secured on said axle and rotated in concert with said axle, a sleeve secured in said rotary member, and a unidirectional bearing member engaged between said sleeve and said barrel.

3. The unidirectional wheel driving assembly according to claim 2, wherein said sleeve includes at least one protrusion extended therefrom and engaged into said rotary member for solidly securing said sleeve to said rotary member.

4. The unidirectional wheel driving assembly according to claim 1, wherein said coupling means includes a pulley secured to said motor, and a belt coupled between said pulley and said rotary member.
